(19) United States
(12) Patent Application Publication
(10) Pub. No.: US 2014/0311797 A1
(43) Pub. Date: Oct. 23, 2014

(54) ELECTRIC WIRE CONNECTION STRUCTURE AND ELECTRIC WIRE CONNECTION METHOD

(71) Applicant: YAZAKI CORPORATION, Tokyo (JP)

(72) Inventors: Yuki NUMATA, Makinohara-shi (JP); Ayako SHIMIZU, Makinohara-shi (JP)

(73) Assignee: YAZAKI CORPORATION, Tokyo (JP)

(21) Appl. No.: 14/252,008

(22) Filed: Apr. 14, 2014

(30) Foreign Application Priority Data
Apr. 17, 2013 (JP) 2013-086315

(51) Int. Cl. H02G 15/06; H02G 1/14

(52) U.S. Cl. CPC H02G 15/06; H02G 1/14
USPC 174/75 R; 29/868

(57) ABSTRACT

A structure of an electric wire for connection includes a conductor end portion of the electric wire comprised of a plurality of core wires. The conductor end portion is compressed by press-forming that pressurizes from the side of an outer peripheral surface thereof toward the side of the axis thereof. The conductor end portion is formed with a press-formed surface by the press-forming on an outer peripheral surface thereof, the press-formed surface being a surface that extends in an axial direction of the conductor end portion and being in the shape of steps that come close to the axis of the conductor end portion from a root side of the conductor end portion toward a tip side of the conductor end portion.

### CROSS REFERENCE TO RELATED APPLICATION

This application claims benefit of priority under 35 U.S.C. §119 to Japanese Patent Application No.2013-086315, filed on Apr. 17, 2013, the entire contents of which are incorporated by reference herein.

### BACKGROUND OF THE INVENTION

1. Field of the Invention

The present invention relates to a structure of an electric wire for connection and a method for connecting an electric wire, which is applied to various apparatuses, with a connected portion of a metal terminal or the like.

2. Description of the Related Art

As a structure for electrically connecting an electric wire, which is a strand wire, or the like, made by unifying a plurality of core wires, with a connected portion of a connection terminal (metallic terminal), or the like, Patent Literatures (Japanese Patent Application Laid-Open Publications 2006-172927, 2004-95293, 2009-277445, and 2011-60726) have proposed a structure where a conductor end portion, which is exposed from an outer covering of an electric wire end portion (such as a conductor end portion exposed by removing an insulating covering of an electric wire), is connected with a connected portion at a predetermined connection position of the connected portion by ultrasonic joining.

In order to prevent the occurrence of a burr and a snap of core wires at a conductor end portion during ultrasonic joining, it is desirable to compress the conductor end portion in advance by press-forming in accordance with the shape of a connection position of a connected portion, thereby enhancing reliability (improvement of joining strength and prevention of short circuit) of an electric connection between the conductor end portion and the connection terminal.

### SUMMARY OF THE INVENTION

The present invention has an object to provide a structure of an electric wire for connection and a method for connecting an electric wire capable of enhancing reliability of an electric connection between a conductor end portion and a connected object by improving close adhesion of respective core wires of the conductor end portion, thereby restraining the conductor end portion from coming loose. This prevents the occurrence of a burr or a snap of core wires at the conductor end portion.

According to a first aspect of the present invention, there is provided a structure of an electric wire for connection, the electric wire including: a conductor end portion that is an end portion of the electric wire comprised of a plurality of core wires, wherein the conductor end portion is to be compressed by press-forming that pressurizes from the side of an outer peripheral surface of the conductor end portion toward the side of an axis of the conductor end portion, and to be electrically connected with a connected portion by ultra joining, wherein the conductor end portion is formed with a press-formed surface by the press-forming on an outer peripheral surface thereof, the press-formed surface being a surface that extends in an axial direction of the conductor end portion and being in the shape of steps that come close to the axis of the conductor end portion from a root side of the conductor end portion toward a tip side of the conductor end portion.

According to a second aspect of the present invention, there is provided a method for connecting an electric wire comprising: compressing a conductor end portion of the electric wire, which is comprised of a plurality of core wires, by press-forming that pressurizes from the side of an outer peripheral surface of the conductor end portion toward the side of an axis of the conductor end portion; forming a press-formed surface on the outer peripheral surface of the conductor end portion, the press-formed surface being a surface that extends in an axial direction of the conductor end portion and being in the shape of steps that come close to the axis of the conductor end portion from a root side of the conductor end portion toward a tip side of the conductor end portion; and electrically connecting the conductor end portion with a connected portion by ultrasonic joining.

According to a structure of an electric wire for connection and a method for connecting an electric wire of the present invention, it is possible to enhance reliability of an electric connection between a conductor end portion and a connected object by improving close adhesion of respective core wires of the conductor end portion, thereby restraining the conductor end portion from coming loose. This prevents the occurrence of a burr and a snap of core wires at the conductor end portion.

### BRIEF DESCRIPTION OF THE DRAWINGS

FIG. 1A is a perspective view of a conductor end portion according to an embodiment.

FIG. 1B is a side view of the conductor end portion according to the embodiment.

FIG. 2 is a schematic diagram illustrating press-forming according to the embodiment.

FIG. 3A is a schematic diagram illustrating a state before compression by the press-forming according to the embodiment.

FIG. 3B is a schematic diagram illustrating a state during the compression by the press-forming according to the embodiment.

FIG. 4 is a schematic diagram illustrating a structure for connection according to the embodiment.

FIG. 5 is a schematic diagram illustrating a widely used electric wire.

FIG. 6A is a schematic diagram illustrating a state before press-forming according to widely used press-forming.

FIG. 6B is a schematic diagram illustrating a state after the press-forming according to the widely used press-forming.

FIG. 7A is a schematic diagram illustrating a state before joining by widely-used ultrasonic joining.

FIG. 7B is a schematic diagram illustrating a state of a conductor end portion after the joining by the widely-used ultrasonic joining.

### DESCRIPTION OF THE PREFERRED EMBODIMENT

A structure of an electric wire for connection and a method for connecting an electric wire according to the present invention is capable of electrically connecting a conductor end portion of an electric wire, which is made by unifying a plurality of core wires, with a connected portion of a connection terminal, or the like, by ultrasonic joining. The conductor end portion has a surface that extends along an axial direction of the conductor end portion, on which a press-formed surface in the shape of descending steps (hereinafter referred to as stepped formed-surface) is formed by press-forming in addition to compression of press-forming. The stepped formed-surface comes close to the axis of the conductor end portion from the root side of the conductor end portion toward the tip side of the conductor end portion.

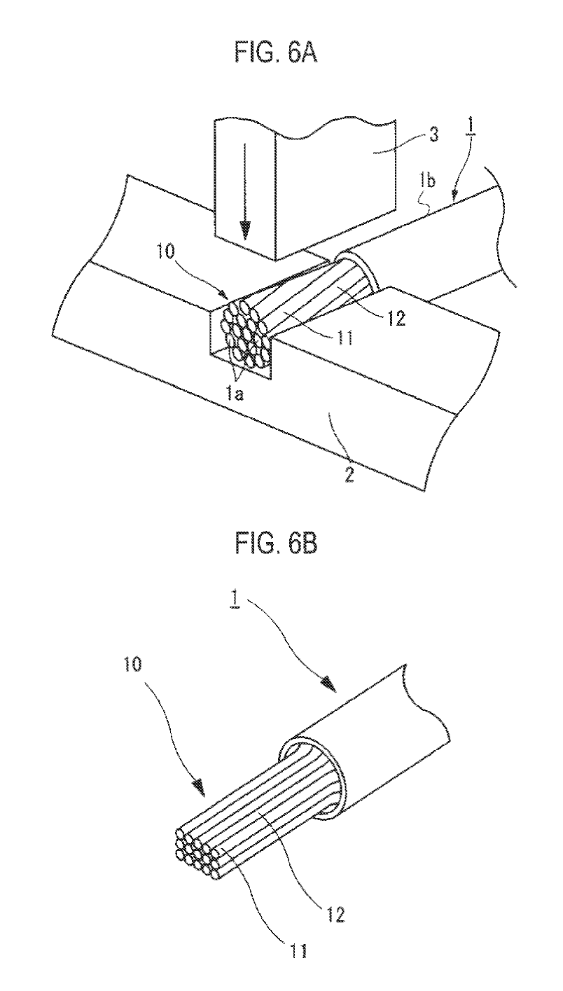

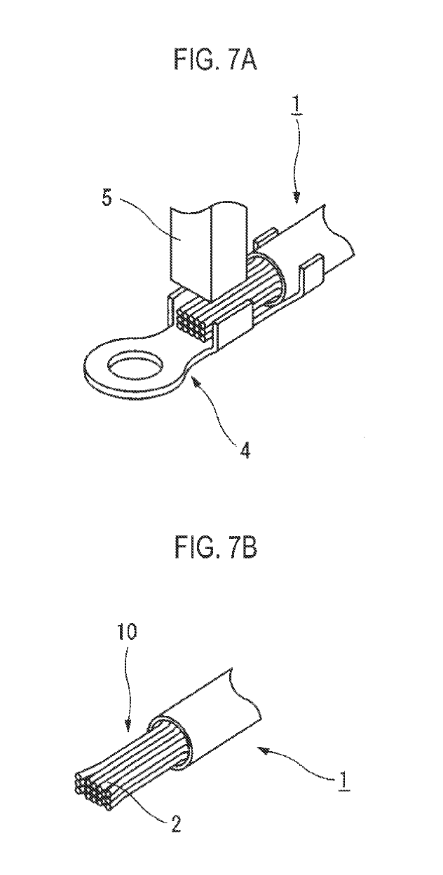

In a conventional structure for connection, at an end portion of an electric wire 1 comprised of a plurality of core wires la as shown in FIG. 5, a conductor end portion 10 exposed from an outer covering lb (for example, conductor end portion 10 exposed by removing an insulating covering) is press-formed by a press-contact mold 3 while fixed by a width regulation mold 2 as shown in FIG. 6A. Thereby, the conductor end portion 10 is compressed in the shape of a nearly flat plate as shown in FIG. 6B. Then, as shown in FIG. 7A, while the compressed conductor end portion 10 is placed in a predetermined connection position of a connected portion 4, the conductor end portion 10 has an outer peripheral surface 12 press-contacted with a pressurization vibration horn 5 of an ultrasonic joining apparatus for pressurization and vibration, so that the conductor end portion 10 and the connected portion 4 are joined by ultrasonic. However, since the conductor end portion 10 vibrates during the ultrasonic joining, if the conductor end portion 10 comes loose on the side of a tip part 11 thereof, the conductor end portion 10 may have a burr and a snap of core wires at the tip part 11 thereof as shown in FIG. 7B. Therefore the reliability of the electric connection between the conductor end portion 10 and the connected portion 4 decreases, such as having a possibility of a decrease in joining strength or the occurrence of a short circuit.

On the other hand, according to the present embodiment, the conductor end portion is press-formed such that a stepped formed-surface is formed on the outer peripheral surface thereof. The conductor end portion is thus compressed firmly by stages from the root side of the conductor end portion toward the tip side of the conductor end portion. This makes the adhesion strength among adjacent core wires increased by stages. Thereby, the adjacent core wires of the tip portion of the conductor end portion are made to adhere sufficiently each other. The conductor end portion is therefore restrained from coming loose, thereby preventing the occurrence of a burr and a snap of core wires at the conductor end portion. Thus, the reliability of an electric connection between the conductor end portion and the connected portion is enhanced.

As the reliability of the electric connection is enhanced (quality is improved) in this way, there is no need of an inspection process, and the like, in later processes, which results in cost reduction. Moreover, the reduction in work processes results in cost reduction of various managements and facilities in the process according to the ultrasonic joining.

According to the present embodiment, the amount of compression of the conductor end portion by the press-forming is made smaller toward the root side of the conductor end portion. That is, it is possible to enhance the close adhesion among adjacent core wires by sufficiently compressing the conductor end portion at the tip side thereof, while the size of the cross section of the conductor end portion on the root side thereof is maintained enough. For example, in a test of pulling force with respect to a connection structure of an electric wire, a stress acts on the conductor end portion at the root side thereof, which has an influence on the strength at the root side. If the size of the cross section of the conductor end portion is maintained enough at the root side as in the present embodiment, the stress can be distributed. Thereby, it is possible to reduce the influence of the stress.

It is possible to appropriately modify the structure of the electric wire for connection and the method for connecting the electric wire according to the present embodiment by applying common techniques in various arts including the electric wire art, the press-forming art, and the ultrasonic joining art, as long as a conductor end portion that is compressed so as to have a stepped formed-surface is electrically connected with a connected portion by ultrasonic joining.

### Stepped Formed-Surface

In the present embodiment, as long as a stepped formed-surface is formed on the outer peripheral surface of the conductor end portion by press-forming, there are no limitations on the shape of a step surface and the shape of a difference surface (for example, a difference surface between step surfaces, a difference surface formed between the root of the conductor end portion and a step surface on the root side), the number of step surfaces, and the number of difference surfaces. For example, according to the shape of the conductor end portion, the connected portion, or the like, it is possible to appropriately decide the shape of a step surface and the shape of a difference surface, the number of step surfaces, and the number of difference surfaces.

Each of the step surfaces of the stepped formed-surface extends flat along the axial direction of the conductor end portion. However, it may extend in an inclined state at a predetermined angle with respect to the axial direction. As a concrete example, there is mentioned a step surface in a tapered shape that inclines so as to come close to the axis of the conductor end portion toward the tip side of the conductor end portion. There is also mentioned a step surface in a tapered shape that inclines so as to come close to the axis of the conductor end portion toward the root side of the conductor end portion. Each of the step surfaces of the stepped formed-surface may be curved along a circumferential direction of the conductor end portion.

A difference surface between adjacent step surfaces, and a difference surface formed between the root of the conductor end portion and a step surface on the root side extend along a diameter direction of the conductor end portion (for example extending along a perpendicular direction of a step surface). However, these may extend in an inclined state at a predetermined angle with respect to the diameter direction of the conductor end portion. As a concrete example, there is mentioned a difference surface in a tapered shape that inclines so as to come close to a tip portion side of the conductor end portion toward the axial side of the conductor end portion. In a case of forming the above-described difference surface in a tapered shape, for example, it is possible to prevent a concentration of a stress on the difference surface during press-forming.

The conductor end portion may include a plurality of stepped formed-surfaces. For example, the plurality of stepped formed-surfaces is formed at a predetermined distance along a circumferential direction of the conductor end portion. As a concrete example, the plurality of stepped formed-surfaces is formed at an equal interval along a circumferential direction. In a case of forming two stepped formed-surfaces, each of the stepped formed-surfaces is formed so as to face each other across the axis of the conductor end portion.

### Press-Forming

As long as a press-forming method is capable of forming a stepped formed-surface on a conductor end portion through press-forming, various methods can be applied. For example, in a case of using a plurality of molds for press-forming, various molds are applied appropriately, such as a width regulation mold for regulating the width in a diameter direction of the conductor end portion and a press-contact mold for press-contacting with the outer peripheral surface of the conductor end portion. At least one of these molds includes a surface that protrudes in a direction to which the conductor end portion is pressurized, on which a protruding surface (hereinafter referred to as stepped protruding-surface) that protrudes in the shape of descending-steps which come close to the axial side of the conductor end portion from the root side of the conductor end portion toward the tip side of the conductor end portion. Thereby, in the press-forming, when a press-contact surface of the mold (press-contact surface formed with the stepped protruding-surface) press-contacts with the outer peripheral surface of the conductor end portion, the shape of the press-contact surface of the mold is reflected on the outer peripheral surface of the conductor end portion. This forms the stepped protruding-surface on the outer peripheral surface of the conductor end portion.

As a width regulation mold, there is mentioned a structure that has a linear groove into which the conductor end portion is fitted. The structure regulates the width in a diameter direction of the conductor end portion, which is fitted into the linear groove, by inner wall surfaces of the linear groove. The shape of the linear groove (for example, the width of the linear groove) can be appropriately set in accordance with the shape of the conductor end portion or a connected portion. As a concrete example, there is mentioned a linear groove that has a flat bottom wall and two side walls which extend from the bottom wall in a perpendicular direction.

As a press-contact mold, there is mentioned a structure that has a press-contact surface which press-contacts with the outer peripheral surface of the conductor end portion. The press-contact surface is formed with a stepped protruding-surface at a position opposing to the outer peripheral surface of the conductor end portion. There are no particular limitations on the shape of a step surface and the shape of a difference surface, both surfaces comprising the stepped protruding-surface (for example, the shape of a difference surface between step surfaces and a step surface formed between the root of the conductor end portion and a step surface on the root side), the number of step surfaces, and the number of difference surfaces. For example, according to the shape of the stepped formed-surface, or the like, it is possible to appropriately define the shape of a difference surface between step surfaces and the shape of a step surface formed between the root of the conductor end portion and a step surface on the root side, the number of step surfaces, and the number of difference surfaces.

A press-forming method is not limited to a combination of the width regulation mold and the press-contact mold applied in the press-forming of an embodiment, which will be described later. Only the press-contact mold may be applied to the press-forming. As a concrete example, there is mentioned a press-contact mold capable of moving a plurality of mold members from respective positions spaced each other in a circumferential direction on the side of the outer periphery surface of the conductor end portion toward the side of the axis of the conductor end portion. There is also mentioned a press-contact mold capable of simultaneously pressurizing the outer peripheral surface of the conductor end portion by a plurality of mold members having press-contact surfaces, respectively, which are arranged along a circumferential direction with respect to the outer peripheral surface of the conductor end portion (for example, press-contact surfaces which press-contact at adjacent positions or at separated positions by a predetermined distance).

### Others

As an ultrasonic joining method, various methods can be applied as long as the method is for joining the conductor end portion with the connected portion for an electric connection. For example, there is mentioned a method using a pressurization vibration horn which gives ultrasonic vibrations on the conductor end portion placed at a connection position of the connected portion, while pressurizing the same (see method disclosed in Patent Literatures 1 to 4).

Since the conductor end portion and the connected portion are electrically connected with each other by ultrasonic joining, a connection terminal (metallic terminal) made of an electrical conducting material such as copper is preferable as the connected portion. The connected portion is however not limited to a connection terminal made of an electrical conducting material.

The shape of the press-formed conductor end portion may be any shape as long as the stepped formed-surface is formed thereon. Other areas than the stepped formed-surface of the conductor end portion may have various shaped cross sections including a rectangular cross section, a disc-shaped cross section, and an ellipse cross section, but not limited to these shapes.

Next, an example of a structure of an electric wire for connection and a method for connecting an electric wire according to the present embodiment will be described based on an embodiment. It is noted that the present invention is not limited to the following embodiment. In the following embodiment and the second embodiment, detailed descriptions for the same elements in FIGS. 5 to 7 will be omitted by using the same reference numbers.

### EMBODIMENT

### Example 1

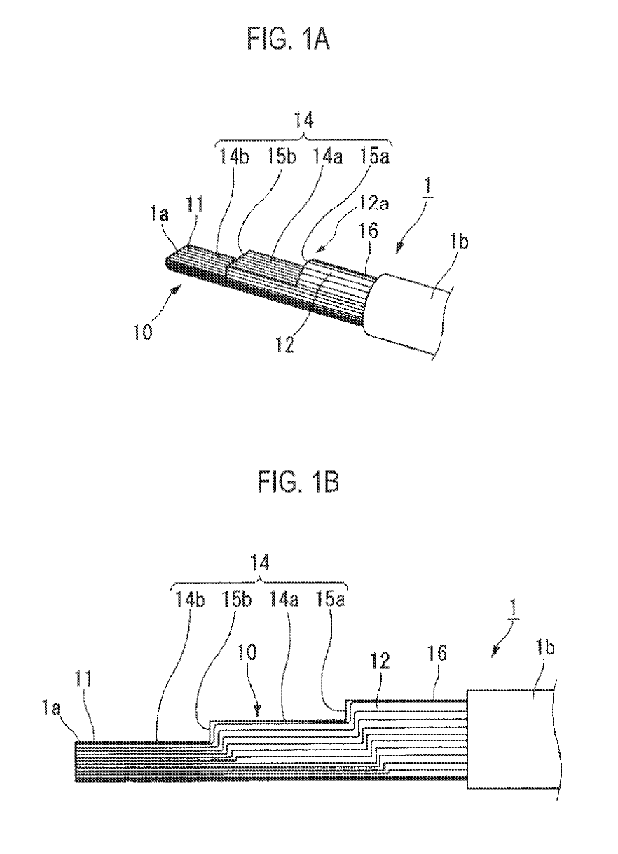

As shown in FIGS. 1A and 1B, a conductor end portion 10 of an electric wire 1 is compressed in the shape of a nearly flat plate (rectangular cross section) by press-forming to pressurize the conductor end portion 10 from a direction of the outer peripheral side toward a direction of the axial side. The press-forming forms a stepped formed-surface 14 on a surface 12a which lies on an outer peripheral surface 12 of the conductor end portion 10. The stepped formed-surface 14 includes a plurality of (two in the present embodiment) step surfaces 14a and 14b, a difference surface 15a between a root 16 of the conductor end portion 10 and the step surface 14a on the root 16 side, and a difference surface 15b between the step surfaces 14a and 14b.

The conductor end portion 10 is more compressed at the area where the stepped formed-surface 14 is formed in comparison with other areas, so that core wires la adhere tightly. In particular, at the closest area to the axis of the conductor end portion 10 on the stepped formed-surface 14, that is the area of the step surface 14b which lies on the tip 11 side of the conductor end portion 10, the conductor end portion 10 is compressed more firmly so that the core wires la adhere more tightly. On the other hand, although the area of the step surface 14a, which lies on the root 16 side of the conductor end portion 10, has a smaller amount of compression than that of the step surface 14b, the cross section of the step surface 14a is maintained larger than that of the step surface 14b.

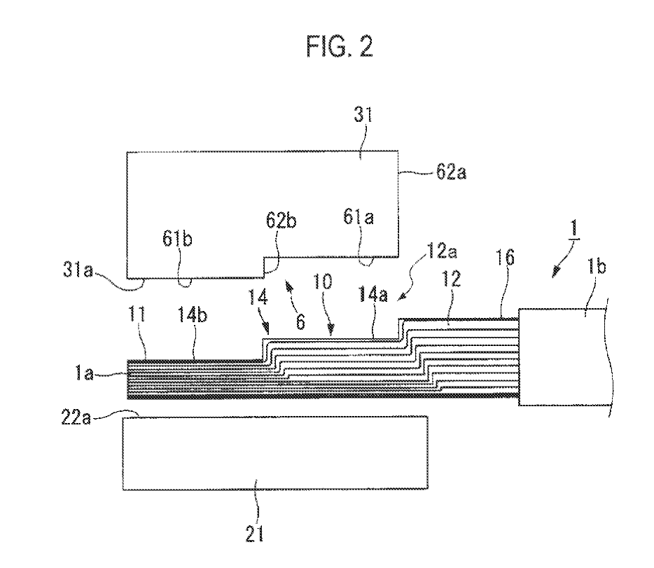

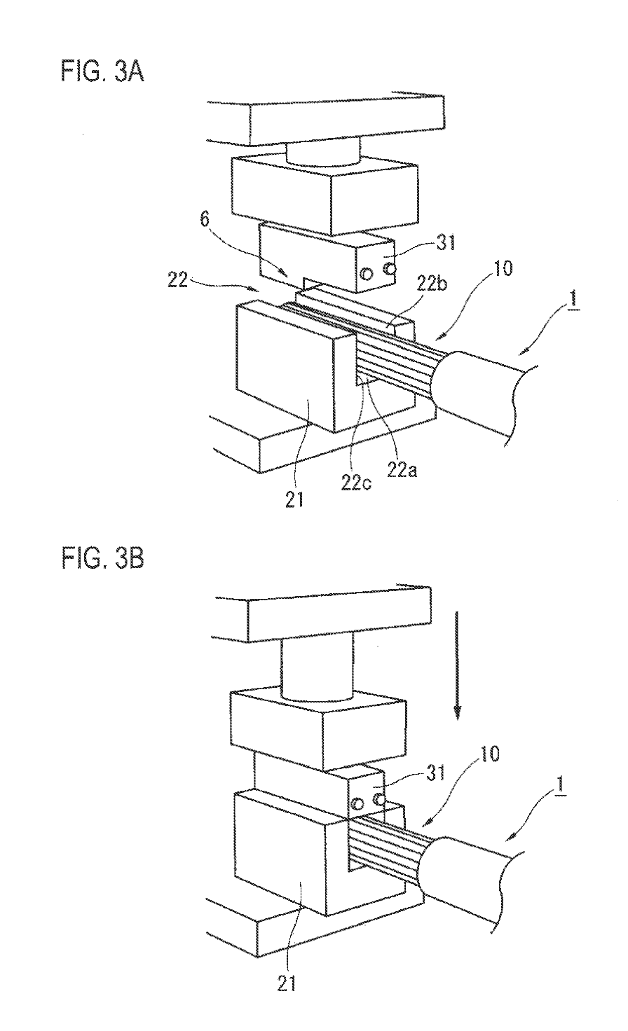

As shown in FIGS. 2, and 3, the stepped formed-surface 14 of the conductor end portion 10 is formed by pressing the conductor end portion 10 using a press-forming apparatus. The press-forming apparatus includes a width regulation mold 21 and a press-contact mold 31. The width regulation mold 21 includes a linear groove 22 into which the conductor end portion 10 is fitted. The linear groove 22 includes a flat bottom wall 22a, and side walls 22b and 22c provided to stand so as to extend in a perpendicular direction from the bottom wall 22a. The press-contact mold 31 is supported movable from a direction of the outer periphery surface side of the conductor end portion 10 toward a direction of the axial side of the conductor end portion 10.

As shown in FIG. 2, a press-contact surface 31a of the press-contact mold 31 is formed with a stepped protruding-surface 6 at a position opposing to the surface 12a (at a position for forming the stepped formed-surface 14). The stepped protruding-surface 6 is a surface that protrudes in a direction to which the conductor end portion 10 is compressed, and is in the shape of descending steps that come close to the axial side of the conductor end portion from the root 16 side of the conductor end portion 10 toward the tip side. The stepped protruding-surface 6 includes a plurality of (two in the present embodiment) step surfaces 61a and 61b, a difference surface 62a on the root 16 side at the step surface 61a, and a difference surface 62b between the step surfaces 61a and 61b.

As shown in FIG. 3A, the width regulation mold 21 and the press-contact mold 31 are arranged such that the flat bottom wall 22a of the linear groove 22 of the width regulation mold 21 and the press-contact surface 31a of the press-contact mold 31 face each other. As shown in FIG. 3B, while the conductor end portion 10 is fitted into the linear groove 22, the press-contact mold 31 is moved toward the width regulation mold 21, and thereby the conductor end portion 10 is compressed in the shape of a nearly flat plate. This forms the stepped formed-surface 14 on the conductor end portion 10.

0034

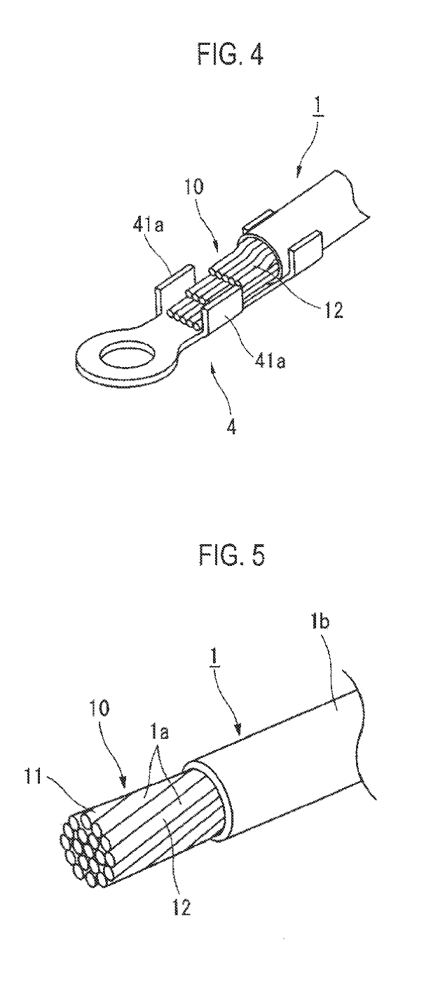

As shown in FIG. 4, the conductor end portion 10 that is formed with the stepped formed-surface 14 is placed at a connection position between side walls 41a and 41a of a connection terminal 4. In this state, in the same method as that of FIG. 7A, the conductor end portion 10 has a pressurization vibration horn 5 press-contacted with the outer peripheral surface 12 for pressurization and vibration, and thereby the conductor end portion 10 is electrically connected with the connection terminal 4.

As described above, the present embodiment describes concrete examples of a structure of an electric wire for connection and a method for connecting an electric wire of the present invention. Various modifications, and the like, are however possible within the scope of the technical idea of the present invention. These modifications, and the like, belong to the scope of claims.

What is claimed is:

1. A structure of an electric wire for connection, the electric wire comprising:
a conductor end portion that is an end portion of the electric wire comprised of a plurality of core wires, wherein the conductor end portion is to be compressed by press-forming that pressurizes from the side of an outer peripheral surface of the conductor end portion toward the side of an axis of the conductor end portion, and to be electrically connected with a connected portion by ultra joining,
wherein the conductor end portion is formed with a press-formed surface by the press-forming on an outer peripheral surface thereof, the press-formed surface being a surface that extends in an axial direction of the conductor end portion and being in the shape of steps that come close to the axis of the conductor end portion from a root side of the conductor end portion toward a tip side of the conductor end portion.

2. The structure of the electric wire for connection according to claim 1, wherein
the press-formed surface includes a step surface that is in a tapered shape.

3. The structure of the electric wire for connection according to claim 1, wherein
the press-formed surface includes a difference surface that is in a tapered shape.

4. The structure of the electric wire for connection according to claim 1, wherein
a plurality of press-formed surfaces is formed at a predetermined distance along a circumferential direction of the conductor end portion.

5. A method for connecting an electric wire comprising:
compressing a conductor end portion of the electric wire, which is comprised of a plurality of core wires, by press-forming that pressurizes from the side of an outer peripheral surface of the conductor end portion toward the side of an axis of the conductor end portion;
forming a press-formed surface on the outer peripheral surface of the conductor end portion, the press-formed surface being a surface that extends in an axial direction of the conductor end portion and being in the shape of steps that come close to the axis of the conductor end portion from a root side of the conductor end portion toward a tip side of the conductor end portion; and
electrically connecting the conductor end portion with a connected portion by ultrasonic joining.

6. The method for connecting an electric wire according to claim 5, wherein
the press-formed surface includes a step surface that is in a tapered shape.

7. The method for connecting an electric wire according to claim 5, wherein
the press-formed surface includes a difference surface that is in a tapered shape.

8. The method for connecting an electric wire according to claim 5, further comprising:
using, for the press-forming, a width regulation mold that has a linear groove into which the conductor end portion is to be fitted, the regulation mold regulating the width in a diameter direction of the conductor end portion by an inner wall surface of the linear groove, and a press-contact mold that has a press-contact surface, the press contact surface press-contacting with the outer peripheral surface of the conductor end portion, which is fitted into the linear groove, from a direction of an opening side of the linear groove,
wherein at least one of the inner wall surface of the linear groove of the width regulation mold and the press-contact surface of the press-contact mold is formed with a protruding surface at a position opposing to the outer peripheral surface of the conductor end portion, the protruding surface being a surface that protrudes in a direction to which the conductor end portion is pressurized and protruding in the shape of steps that come close to an axial side of the conductor end portion from the root side of the conductor end portion toward the tip side of the conductor end portion.
